(19) United States
(12) Patent Application Publication
(10) Pub. No.: US 2003/0090110 A1
(43) Pub. Date: May 15, 2003

(54) Piping coupler

(76) Inventor: Young Chul Choi, Seoul (KR)

Correspondence Address: BACON & THOMAS, PLLC, 625 SLATERS LANE, FOURTH FLOOR, ALEXANDRIA, VA, 22314

(21) Appl. No.: 10/162,923

(22) Filed: Jun. 6, 2002

(30) Foreign Application Priority Data
Nov. 13, 2001 (KR) 2001-34851

(51) Int. Cl. F16L 37/00

(52) U.S. Cl. 285/307

(57) ABSTRACT

The invention is a piping coupler which can be easily and quickly disconnected even at the time of a high hydraulic pressure working.

The invention is a piping coupler comprising a pipe-formed housing 10 formed inside with a flow passage passing through the opposite ends and a taper section or surface 8, the taper section being formed at the inner wall of the housing, the taper section tapering toward the proximal end of the housing, and a clip 30 expandable radially due to longitudinal slits, formed with an engagement step 26 protrusively on the circumferential end of the clip 30, the clip being inserted in said flow passage to be movable along the flow passage, wherein a cap 40 surrounding the outer circumference of the housing 10 so as to be movable back and forth together with the clip 30 and having a grip section 42, radially extended from the outer circumference of the cap, is provided, and easy detachment of a pipe 1 is possible by pushing said grip section 42 of the cap 40.

### FIELD OF THE INVENTION

The present invention relates to a piping coupler and more particularly a piping coupler which can be easily and quickly disconnected even when the piping contains a high hydraulic pressure without using a separate tool like a spanner.

### BACKGROUND OF THE INVENTION

Generally, water purifiers or the like include a multitude of pipes connected to external running water pipe systems by means of piping couplers in order to be supplied with water. A typical piping coupler comprises, as shown in FIG. 1, a tubular housing 10 provided with a step 4 at one end 2 and with a taper section 8 at the other end 6, the step and taper section being formed at the inner walls of the ends, the inner diameter of the taper section 8 being reduced inwardly toward the proximal end of the housing 10, a valve body 20 supported elastically by a spring 12 and formed with a flow passage 14 in the valve body, the spring 12 being supported on the step 4, and a clip 30 inserted inside the other (proximal) end 6 of the housing 10. Further, the clip 30 includes a cylindrical portion 22 extensible radially due to longitudinal slits formed through its wall, a flange 24 in contact with the other (proximal) end 6 of the housing 10 and an engagement step 26 protruding on the circumferential end of the cylindrical portion 22.

Accordingly, when a pipe 1 is connected to the one end 2 of the housing 10 and a tube 3 is inserted in the other end 6, the tube 3 pushes the valve body 20 toward the end 2 of the housing 10, so that the cylindrical portion 22 gets decreased in its diameter under the inner tapering section 8 to press down the tube 3 to thereby achieve fixing. In disconnection, pushing the clip 30 into the housing 10 by using a finger or tool would allow the cylindrical portion 22 to expand radially to thereby release it from the tube 3, whereby the tube 3 can be pulled out.

In particular, the piping coupler is usually detached by the process in which the clip 30 is pushed into the housing 10 by a finger applied to the front part of the clip, with the circumference of the housing 10 held by a hand of a user so as to disengage the tube 3. Under a high hydraulic pressure, for example 4 kg/cm² or over, however, it is very hard to push the clip 30 with a finger or a tool. In spite of a considerable force required to overcome the hydraulic pressure, the area of the clip 30 available for gripping is not large enough and therefore the tube 3 can not be so easily detached. Specially, for a narrow space in which a number of chords and pipes are arranged, as in the case of water purifying appliance, pushing the clip 20 to detach the tube 3 is further difficult. The possible need for a separate tool like a spanner is also a problem as an inconvenience.

### SUMMARY OF THE INVENTION

The present invention is intended to resolve the problem as described above and the object of the invention is to provide a piping coupler which can be easily and quickly disconnected even in the case of a high hydraulic pressure within the piping without using a separate tool like a spanner.

The object as described above is achieved according to an aspect of the invention by a piping coupler comprising a pipe-formed housing 10 formed inside with a flow passage passing through the opposite ends and a taper section or surface 8, the taper section being formed at the inner wall of the housing, the taper section tapering toward the proximal end of the housing, and a clip 30 expandable radially due to longitudinal slits, formed with an engagement step 26 protruding on the circumferential end of the clip 30, the clip being inserted in said flow passage to be movable along the flow passage, and a cap 40 surrounding the outer circumference of the housing 10 so as to be movable back and forth together with the clip 30 and having a grip section 42, radially extended from the outer circumference of the cap, thereby permitting easy detachment of a pipe 1 by pushing said grip section 42 of the cap 40.

### BRIEF DESCRIPTION OF THE DRAWINGS

FIG. 1 shows the cross section of a conventional piping coupler,

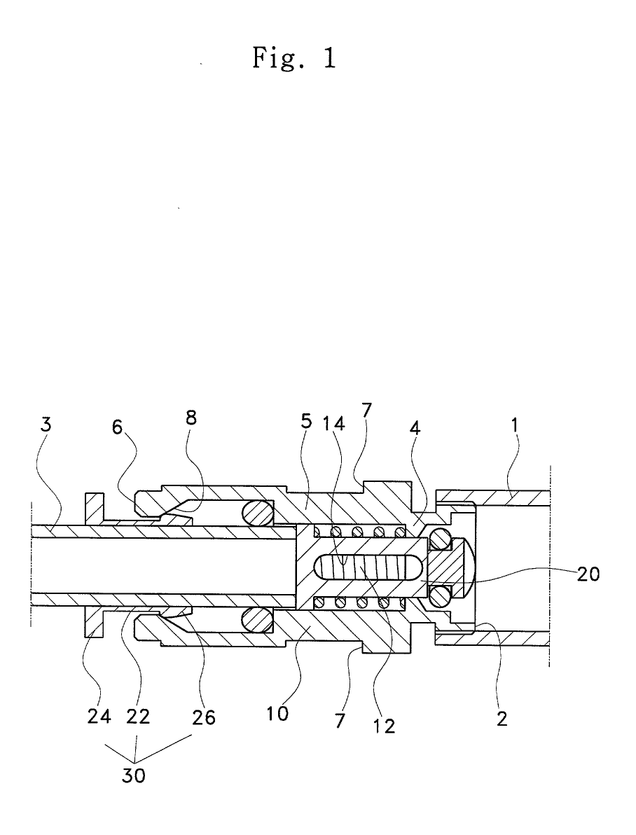

FIG. 2 shows the cross section of a piping coupler, with a pipe connected, according to a preferred embodiment of the invention and

FIG. 3 shows the cross section of a piping coupler of FIG. 2 during the detachment operation.

FIG. 4 shows another embodiment of the invention.

### DETAILED DESCRIPTION OF THE INVENTION

The invention is described in detail below in accordance with a preferred embodiment with reference to the accompanying drawings.

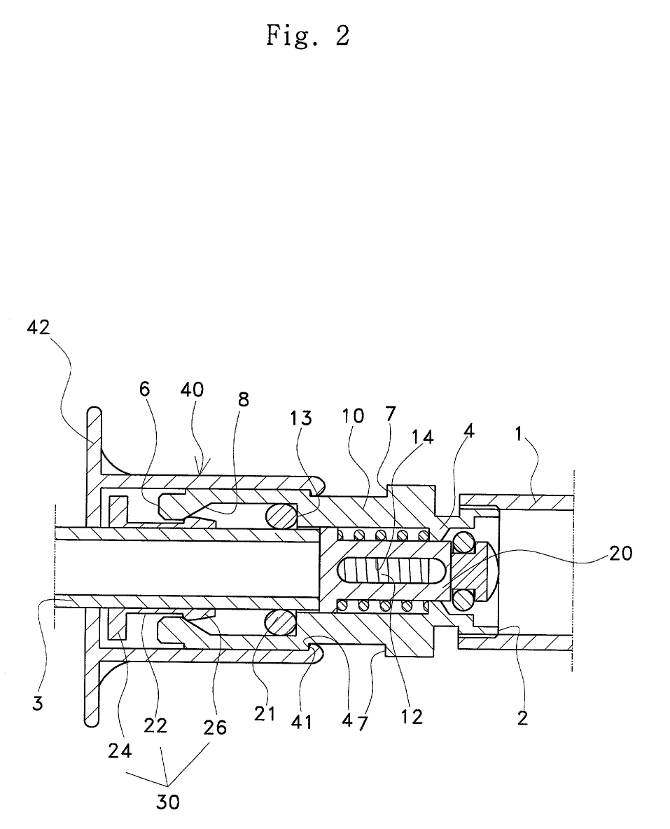

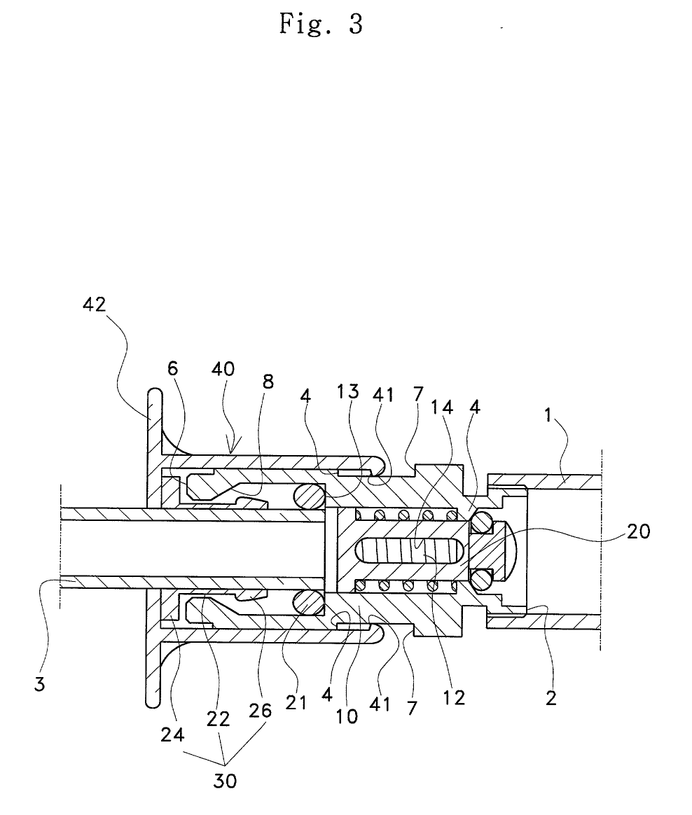

FIGS. 2 and 3 show piping couplers according to the invention in cross section. Referring to these drawings, the piping coupler comprises a tubular housing 10, a clip 30 inserted in the flow passage of the housing 10, and a cap 40, which is fitted on the cylindrical part of the housing 10 and has a protruding grip section 42 radially extending from the outer circumference of the cap.

The housing 10, a tubular body, which is formed with a flow passage running through the opposite ends of the housing, is connected to a pipe 1 of a metal or synthetic resin at one end 2 and with a tube 3 at the other end. On the inner bore at the one end 2 of the housing 10 a step 4 is formed projecting inwardly to support a spring 12, which spring is provided inside the step 4 to elastically guide the reciprocal movement of a valve body 20 formed with a passage 14 therein. Further, on the inner bore at the other end 6 of the housing 10 a taper section 8 tapering inwardly toward the end 6 is formed, and on the inner bore of the housing 10 between the taper section 8 and the valve body 20 another step 13 projecting inwardly and fitted with a packing ring 21 is formed.

The clip 30 fitted inside the other end 6 of the housing 10 in reciprocal manner includes a cylindrical section 22, a flange section 24 and an engagement step 26. The cylindrical section 22, which is coupled with the other end of the housing 10 so as to movable back and forth, is formed with plural slits or longitudinal openings (not shown) so as to expand and contract radially. Accordingly, this section is reduced in diameter due to the taper section 8 inside the housing 10 when this section is slid toward the end 6 of the housing 10, while sliding movement of the cylindrical section 22 in an inward direction of the housing 10 would allow the increase in the diameter of this section. At the base part of the cylindrical section 22 there is provided circumferential engagement step 26, which acts to prevent the clip 30 from falling off or separating from the housing by keeping it engaged within the housing, while at the front part of the cylindrical section 22 there is provided a flange 24 to limit the movement of the clip 30 into the housing 10 by the contact of the flange with the end surface 6.

The cap 40 which is movable longitudinally is fitted on the circumference of the housing 10 and includes a grip section 42 protruding radially on the cylindrical cap body. At the base of the cap 40 there is formed an engagement section 41 oriented inwardly for protection against falling off or separation from the housing 10 by engagement of the section 41 with an annular step 7 formed on the external circumference of the housing 10.

A tube 3 inserted in the cylindrical section 22 of the clip 30 can be secured or released, as mentioned above. Specifically, when an insertion of a tube 3 is made, the leading tip of the tube 3 is brought in hermetical contact with a packing ring 21 supported inside the housing 10 to pass the ring and causes the valve body 20 to advance against the elastic tension of a spring 12, so that the passage 14 inside the valve body 20 may be in communication with the side of the pipe 1. Subsequently, when pushing force is now let up, the tube 3 is retracted by the elastic restoring force of the spring 12 via the valve body 20 until the engagement step 26 at the circumferential end of the cylindrical section 22 of the clip 30 is contacted with the taper section 8 of the housing 10 to increasingly contract the cylindrical body 22, with the result that the tube 3 is finally fixed under the pressure from cooperation of the step 26 and taper section 8.

On the other hand, when the detachment of the tube 3 is desired, the cap 40 is pushed into the housing 10 to engage clip 30 with a hand holding the grip section 42 having a wide area, to allow the expansion in the diameter of the cylindrical section 22 with the inward movement of the clip 30 together with the cap 40, so that the tube 3 can be released with ease or without difficulty in applying force.

Here, because the clip 30 is guided together with the cap 40 which is guided along the outer surface of the housing 10, equal force can be applied to the clip 30 compared with the case that the flange 24 of the clip 30 is gripped and pulled by fingers. Therefore, the clip 30 can be readily moved and the tube 3 can be easily released.

Thus, based on the arrangement that a cap 40 is fitted on the circumferential end part of the housing 10 so as to be movable axially and is provided radially with a grip section 42, the disconnection of the tube 3 can be made easily and rapidly by holding the grip 42 with a hand and pushing it lightly in the direction toward the pipe even in the case of a high hydraulic pressure, e.g. 4 kg/cm² or higher. A narrow space for the water purifying device or the like, including complicated wiring or piping, would make no problem and the use of an additional tool like a spanner is dispensed with.

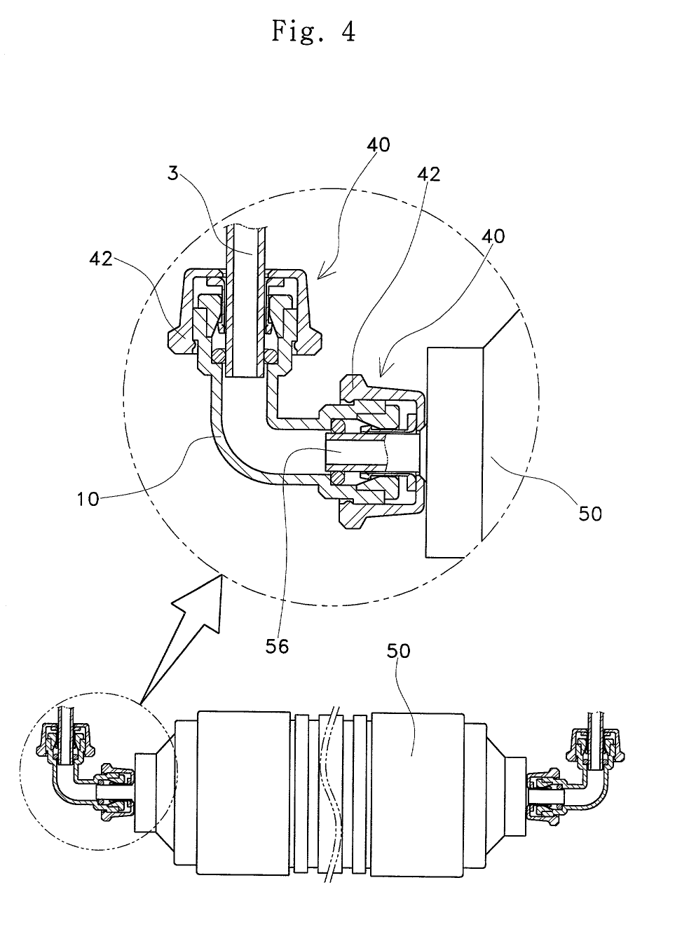

Further, as shown in FIG. 4, the piping connector of the invention can also be used for connecting a water purifier filter case 50 and the tube 3.

Here, because the grip section 42 is protruded on the circumference of the cap 40 of the opposite side of the filter case 50, a gap is formed between the grip section 42 and the end of the filter case 50. Accordingly, when a user inserts fingers into the gap between the grip section 42 and the end of the filter case 50, and pushes the cap 40 toward the opposite side of the filter case 50, the housing 10 can be easily disconnected from the port 56 of the filter case 50.

Moreover, it is to be understood that, while the invention was described mainly with respect to a preferred embodiment, the invention is not restricted to that specific embodiment and a variety of modifications and alterations would be possible to a man skilled in the art by referring to the description or drawings presented here and within the spirit of the invention and thus those modifications or alterations are to fall within the scope of the invention, which scope should be limited only by the attached claims.

1. A piping coupler comprising a pipe-formed housing 10 formed inside with a flow passage passing through the opposite ends and a taper section or surface 8, the taper section being formed at the inner wall of the housing, the taper section tapering toward the proximal end of the housing, and a clip 30 expandable radially due to longitudinal slits, formed with an engagement step 26 protrusively on the circumferential end of the clip 30, the clip being inserted in said flow passage to be movable along the flow passage, wherein a cap 40 surrounding the outer circumference of the housing 10 so as to be movable back and forth together with the clip 30 and having a grip section 42, radially extended from the outer circumference of the cap, is provided, and easy detachment of a pipe 1 is possible by pushing said grip section 42 of the cap 40.
